(19) United States
(12) Patent Application Publication
(10) Pub. No.: US 2004/0208197 A1
(43) Pub. Date: Oct. 21, 2004

(54) Method and apparatus for network protocol bridging

(76) Inventor: Swaminathan Viswanathan, San Jose, CA (US)

Correspondence Address: IRELL & MANELLA LLP, 840 NEWPORT CENTER DRIVE, SUITE 400, NEWPORT BEACH, CA, 92660, US

(21) Appl. No.: 10/414,632

(22) Filed: Apr. 15, 2003

(51) Int. Cl. H04L 12/28

(52) U.S. Cl. 370/466

(57) ABSTRACT

A method and apparatus for network protocol bridging is disclosed. In one embodiment, data packets are received from a first network interface having a first protocol. A packet processing engine, which is comprised of both hardware and software components, is then used to perform a route lookup operation for each packet received, where the route lookup operation provides route information for the data packets. Based on this route information obtained from the route lookup operation, the packet processing engine routes the data packets through an internal fabric interface and to a second network interface having a second protocol.

### BACKGROUND OF THE INVENTION

1. Field of the Invention

The present invention relates in general to data networks and more particularly, to a method and apparatus for network protocol bridging.

2. Background Information

Fibre Channel is a computer communications protocol designed to provide for higher performance information transfers. Fibre Channel allows various existing networking protocols to run over the same physical interface and media. In general, Fibre Channel attempts to combine the benefits of both channel and network technologies.

A channel is a closed, direct, structured, and predictable mechanism for transmitting data between relatively few entities. Channels are commonly used to connect peripheral devices such as a disk drive, printer, tape drive, etc. to a workstation. Common channel protocols are Small Computer System Interface (SCSI) and High Performance Parallel Interface (HIPPI).

Networks, however, are unstructured and unpredictable. Networks are able to automatically adjust to changing environments and can support a larger number of connected nodes. These factors require that much more decision making take place in order to successfully route data from one point to another. Much of this decision making is done in software, making networks inherently slower than channels.

Fibre Channel has made a dramatic impact in the storage arena by using SCSI as an upper layer protocol. Compared with traditional SCSI, the benefits of mapping the SCSI command set onto Fibre Channel include faster speed, connection of more devices together and larger distance allowed between devices. In addition to bridging the SCSI protocol across Fibre Channel, SCSI may similarly be used in connection with Internet Protocol (IP) networks (e.g., LAN/WAN) and InfiniBand (IB) networks (e.g., system area networks).

The practice of bridging the protocols across Fibre Channel, IP and IB continues to expand into the storage markets. However, current methods for network protocol bridging suffer from numerous drawbacks, including performance degradation at higher link speeds. Thus, there is a need for an improved method and apparatus for performing network protocol bridging that minimizes performance degradation.

### SUMMARY OF THE INVENTION

Methods and apparatus for network protocol bridging are disclosed. One method comprises receiving a data packet on a first network interface having a first protocol, and performing a route lookup operation for the data packet using one or more hardware components and one or more software components, wherein said route lookup operation provides route information for the data packet. The method further comprises routing the data packet, using the route information, to a second network interface having a second protocol.

Other embodiments are disclosed and claimed herein.

### BRIEF DESCRIPTION OF THE DRAWINGS

FIG. 1 is a system-level block diagram of one embodiment of a system that carries out one or more aspects of the present invention.

FIG. 2 is a block diagram of one embodiment of a line card that implements one or more aspects of the present invention.

FIGS. 3A-3B each illustrate an embodiment of a simple route table that may included as part of the line card of FIG. 2.

FIG. 4 is a flow diagram for one embodiment of a process for generating a hash tree that is consistent with the principles of the invention.

FIG. 5 depicts one embodiment a packet storage memory that may be a component of the line card of FIG. 2.

FIG. 6 depicts one embodiment of an entry in an ingress header processing queue consistent with the principles of the present invention.

FIG. 7A is a flow diagram for one embodiment of how ingress data may be processed using a Tunneling Mode of the line card of FIG. 2.

FIG. 7B is a flow diagram for one embodiment of how egress data may be processed using a Tunneling Mode of the line card of FIG. 2.

FIG. 8A-8B are flow diagrams of embodiments for SCSI processing of ingress virtualized data packets may be processing using the line card of FIG. 2.

FIG. 9 is a flow diagram of one embodiment for SCSI processing of egress virtualized data packets using the line card of FIG. 2.

FIG. 10A-10B are flow diagrams of embodiments for IP processing of ingress virtualized data packets may be processing using the line card of FIG. 2.

FIG. 11 is a flow diagram of one embodiment for IP processing of egress virtualized data packets using the line card of FIG. 2.

### DETAILED DESCRIPTION

One aspect of the invention is to provide an improved method and apparatus for network protocol bridging. In one embodiment, a fabric topology interface is used to connect a plurality of devices in a cross-point switched architecture. In another embodiment, a packet processing engine comprised of a combination of hardware and software is used to perform packet header processing. The software portion of the packet processing engine may be provided by a Reduced Instruction Set Computer (RISC) engine, according to one embodiment.

In another embodiment, the packet processing engine processes both command/status packets and data packets in substantially the same manner. In one embodiment, packet processing is done without the use of an external processor.

Another aspect of the invention is to use one or more routing tables to facilitate packet processing. In one embodiment, for each data packet received, an entry in one or more routing table is made indicating the packet's route information. In another embodiment, a Content Addressable Memory (CAM) may be used to point to the route table, or even a particular packet's route entry. A CAM lookup engine may then be used to access the routing information.

Another aspect of the invention is to use a multiple-line-card configuration to provide multi-protocol connectivity across a fabric topology. In one embodiment, the line cards comprising the multiple-line-card configuration are comprised of a line interface and a fabric interface.

I. System Overview

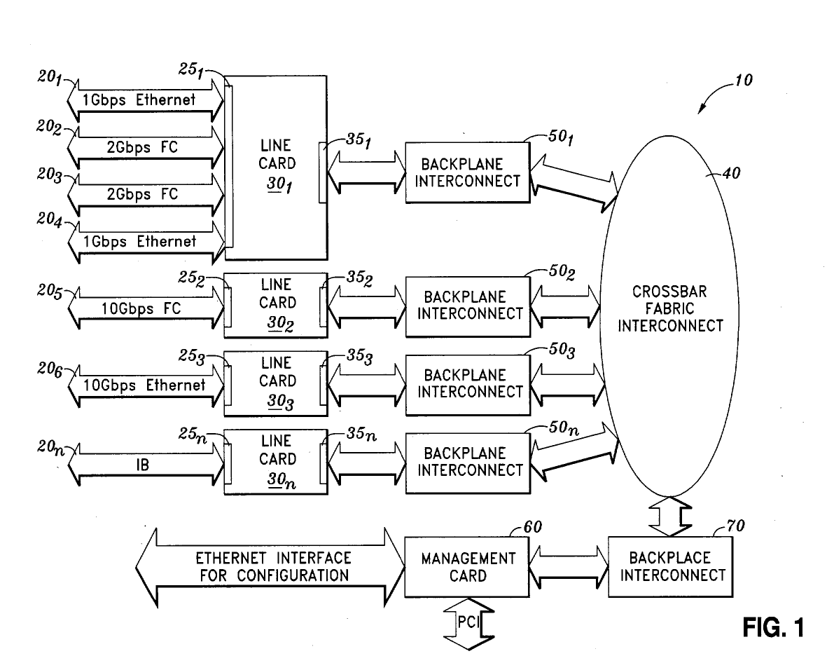

In one embodiment, the invention may be implemented as one or more line cards in a networked environment. To that end, FIG. 1 depicts a simplified schematic of a network interface 10 consistent with the principles of the invention. As shown in FIG. 1, networks 20₁-20ₙ (collectively, “networks 20”) are coupled to line interfaces 25₁-25ₙ (collectively, “line interfaces 25”) of line cards 30₁-30ₙ (collectively, “line cards 30”). Line cards 30 further include fabric interfaces 35₁-35ₙ (collectively, “fabric interfaces 35”) which serve to couple line cards 30 to crossbar interconnect 40 via backplane interconnects 50₁-50ₙ (collectively, “backplane interconnects 30”). It should be appreciated that the backplane interconnects 50 may be any switch/gateway/router capable of connecting line cards 30 to crossbar interconnect 40. Moreover, crossbar interconnect 40 may be used to provide non-arbitrated open communication across all connected systems using a fabric topology (e.g., line cards 30, management card 60, etc.). However, it should equally be appreciated that an arbitrated bus architecture may similarly be used.

In one embodiment, line cards 30 function as native switch ports and perform all operations necessary for a native protocol switch. In another embodiment, one or more line cards 30 are capable of supporting InfiniBand (IB), Fiber Channel (FC) and Gigabit Ethernet interfaces. Moreover, network interface 10 and line cards 30 may be configured to support SCSI (such as FCP for Fiber Channel, SRP for InfiniBand & iSCSI for Ethernet). In one embodiment, SCSI may be terminated at the line-card-level and a proprietary protocol may be used to carry the data through network interface 10. In addition, network interface 10 and line cards 30 may further support IP (e.g., IP over IB & IP Over Ethernet), Remote Direct Memory Access (RDMA) Protocol (e.g., RDMA Over IB and RDMA Over DDP/MPA/TCP), SDP (SDP on IB-SDP Over TCP/IP) and Dual Address Space Feature (DAFS) (DAFS Over IB, DAFS Over VI/Ethernet).

In another embodiment, one or more of the line cards 30 may be set to a Tunneling Mode, in which some data traffic is tunneled and carried through the network interface 10 without terminating the protocol. When set to Tunneling Mode, the input and output line interfaces are the same, according to one embodiment.

Certain management functions for the network interface 10 may be carried out using the management line card 60, which in the embodiment of FIG. 1 is coupled to the crossbar interconnect 40 using backplane interconnect 70. While FIG. 1 depicts only a single Management Line Card 60, it should similarly be appreciated that more than one may be used. In any event, Management Card 60 may execute software for setting up the routing tables for line cards 30, according to one embodiment.

II. Line Card Architecture

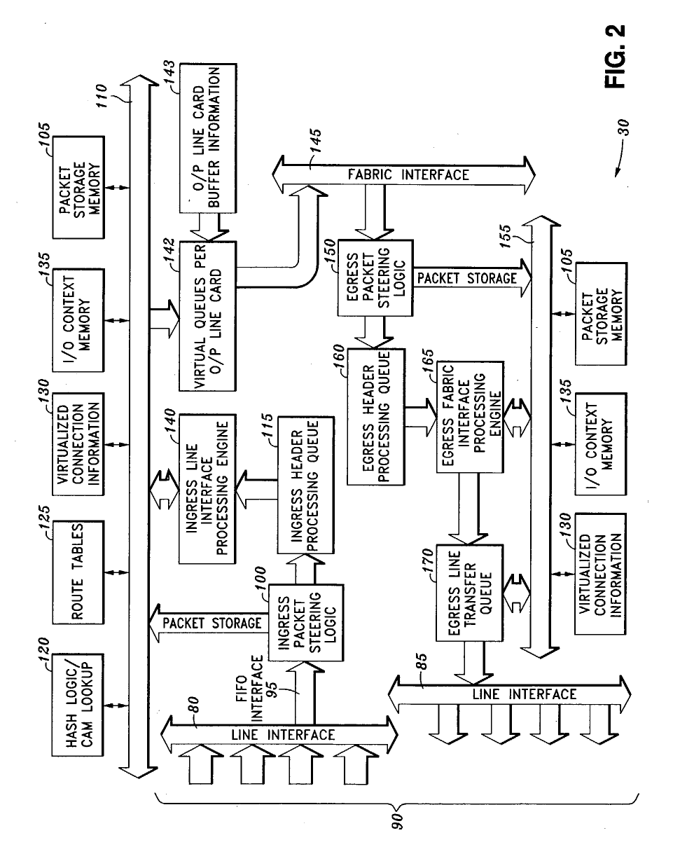

Referring now to FIG. 2, in which one embodiment of a Line Card 30 that may be used in Network Interface 10 is depicted. As shown in FIG. 2, the functionality of Line Card 30 includes ingress line interface processing, egress line interface processing, ingress fabric interface processing and egress fabric interface processing. Moreover, in the embodiment of FIG. 2, each of these processing functions may be carried out using a combination of hardware and software. However, it should be appreciated that these processing functions need not be performed by distinct processing engines, but may similarly be merged or divided into some other number of processing engines.

In the embodiment of FIG. 2, the Line Interface 25 of Line Card 30 has been split into an Ingress Line Interface 80 and an Egress Line Interface 85, where the Ingress Line Interface 80 is used to receive packet data from one or more Network Connections 90 and Egress Line Interface 85 provides packet data to one or more Network Connections 90.

Packet data may be transferred from Ingress Line Interface 80 to Ingress Packet Steering (IPS) logic 100 via FIFO interface 95. In one embodiment, IPS logic 100 is responsible for doing the minimal packet processing required to steer the packet to the Packet Storage Memory 105 (coupled to the IPS logic 100 via internal bus 110) and to the Ingress Header Processing Queue (IHPQ) 115. By way of example, the functions of IPS logic 100 may include packet storage management, storing packets in a linked-list fashion, burst writing to Packet Storage Memory 105, and saving header information in the IHPQ 115 for further processing.

In one embodiment, IHPQ 115 is used to maintain header information for further processing. It should be appreciated that the actual header information that is stored will be dependent, at least in part, on the particular interface and packet protocol. In addition, the header may be processed based on the particular protocol at issue, while a modified header may be stored back to the Packet Storage Memory 105. In another embodiment, the packet may then be scheduled for transmission to the Fabric Interface 145.

Continuing to refer to FIG. 2, hash logic/CAM lookup engines (“Lookup Engines) 120 may be used to gain access to the Route Tables 125 and Virtualization Connection Information (VCI) table 130 in a more rapid manner. If CAM is implemented, the tables and entries may be created by the Management Card 60 after detecting a valid route and creating a flow respectively.

In one embodiment, each CAM entry may hold either a memory address that would point to the actual route table (in block 125) or may hold the route entry itself.

CAM keys may be generated based on the individual line cards and the particular protocol that is received from the Ingress Line Interface 80. If hash is implemented, on the other hand, a link list of the route entry or a binary tree may be created by Management Card 60. In one embodiment, the hash algorithm could be a CRC-32 polynomial function with the keys again decided by the actual line interface protocol.

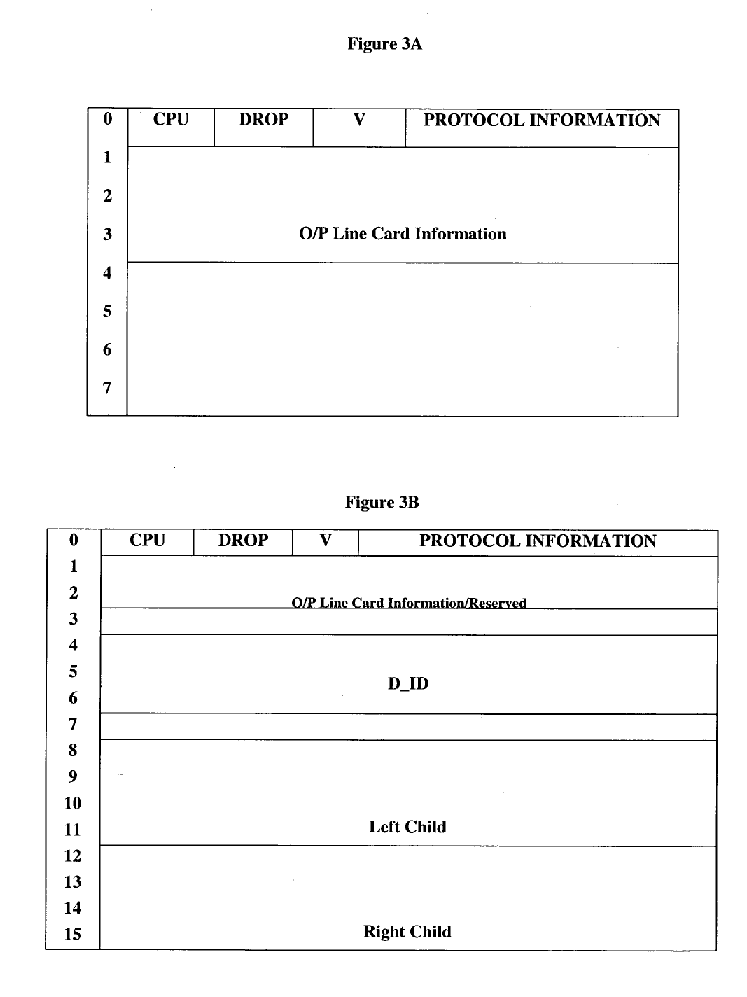

The Route Tables 125 are coupled via internal bus 110 and may contain the route information for a particular packet received on the Ingress Line Interface 80, according to one embodiment. The route entry may be obtained through a CAM lookup engine or by a hashing process (performed by block 120). FIG. 3A depicts one embodiment of a simple route table using a CAM, while FIG. 3B depicts an embodiment of the route table for an FC line interface where searching is done with a binary tree.

In one embodiment, the destination address from a packet may be used to obtain the route table. In the case of IP, IP addresses longest prefix match may be used to obtain the route information. It should be appreciated, however, that the particular field that will be used to obtain the route table will depend at least in part on the line card protocol. By way of example, Fibre Channel protocol may use D_ID, while InfiniBand may use DLID and/or GUID. Similarly, Ethernet may use IP Destination Addresses. Since these fields vary in their size, a Line Card 30 that supports more than one line interface may have route tables that are partitioned for each line interface based on the protocol at issue. Moreover, a Line Card 30 that has multiple physical ports may use port numbers to obtain hash/CAM keys. A combination of CAM/hashing may also be done to limit the size of the CAM. In another embodiment, the route entries can be cached into a fast memory and for every miss, the entry can be fetched from an external memory.

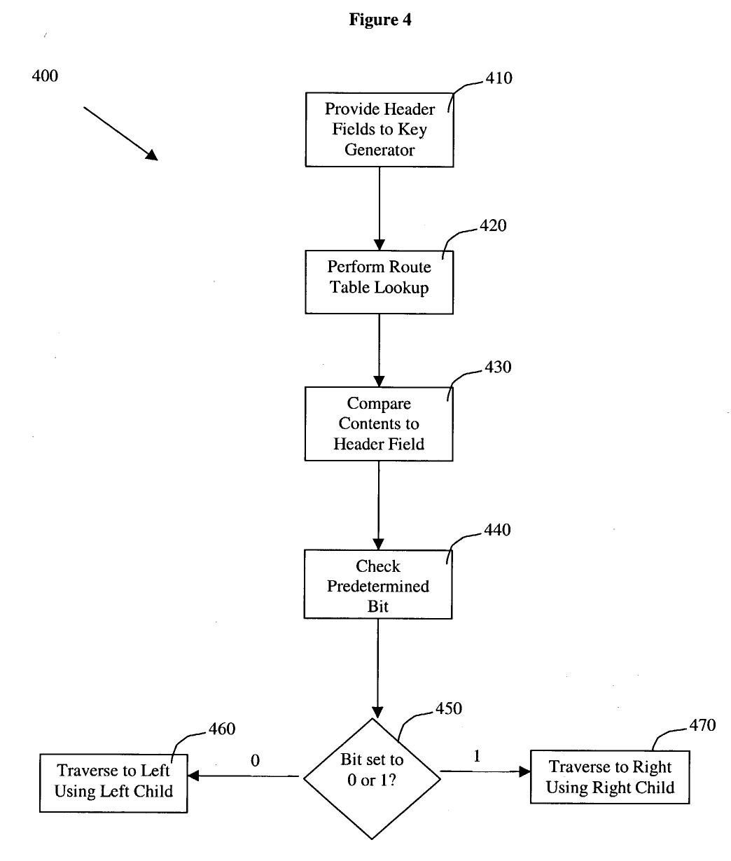

In yet another embodiment, a CRC-32 algorithm could be used to access the start index, while a binary tree could be constructed to access the exact route table. By way of example only, FIG. 4 describes a process 400 for building a hash tree. In particular, at block 410, appropriate header fields that are received are fed off to the hash key generator. In one embodiment, a hash key may be derived. Thereafter, at block 420, a route table lookup is performed using the hashed key (which in one embodiment is a 24-bit key). At block 430, the contents of the route table entry are compared with the header fields until a match is found. Once a match is found, at block 440 process 400 checks a predetermined bit (e.g., the 24th bit) to see if traversing should be done to the left or the right of the binary tree structure. Where the predetermined bit is set to 0, then traversing is done to the left using a left child of the binary tree structure (block 450). Process 400 may then continue with the next memory lookup matching. If, on the other hand, the predetermined bit (e.g., the 24th bit) is set to 1, then traversing is done to the right using the right child, after which process 400 may continue with additional memory lookups. While traversing, if a child node of the data structure is empty (e.g., is NULL), then the packet can be assumed to be without a route entry, and the appropriate action will be taken. This could include either dropping the packet or forwarding it to the Management Card 60. It should equally be appreciated that other methods may be used to determine how the binary tree structure should be traversed.

Referring now back to FIG. 2, information about a virtual connection may be stored in the VCI tables 130. While the contents of these table(s) may depend on the particular protocol being employed, they may be nonetheless initialized by the Management Card 60. Moreover, as mentioned above, a VCI table 130 may be accessed either from a CAM lookup engine or by the hashing mechanism. Examples of possible information that may be contained in the VCI table(s) 130 includes device addresses, unique IDs, and any interface-specific information such BB-Credits, Queue Pair Number (QPN), and TCP Information etc.

VCI table(s) 130 may be created after a connection is established between two devices. In the case of an IP transmission, the connection table may be used only at the egress side (via internal bus 155). For SCSI, a VCI table 130 may be accessed both at the Ingress side (via internal bus 110) as well as the Egress side (via internal bus 155). In one embodiment, a VCI table 130 may be accessed at the ingress side using either a CAM/hashing mechanism, while on the egress side, the table may be directly accessed from the internal fabric header.

For a bi-directional data transfer for a virtual connection, the same table may be accessed both on the ingress side and the egress side, according to one embodiment. In another embodiment, the table fields may have different meanings on the ingress side than on the egress side.

An I/O context memory table 135 may be used to maintain information about a particular I/O that is active. In one embodiment, the I/O context memory table 135 may be setup during the connection setup process and be updated when the data flows through that I/O Flow (i.e., write or read command). The information that is maintained in this table 135 may include both common fields and some protocol-specific fields. For example, common fields may include total transfer size, bytes transferred, pointer to the device handle, direction of the data, etc. Similarly, some protocol-specific fields may include initiator/target tags or exchange IDs, RDMA information, etc. The I/O context memory table 135 may be accessed both on the ingress side (via internal bus 110) as well as the egress side (via internal bus 155).

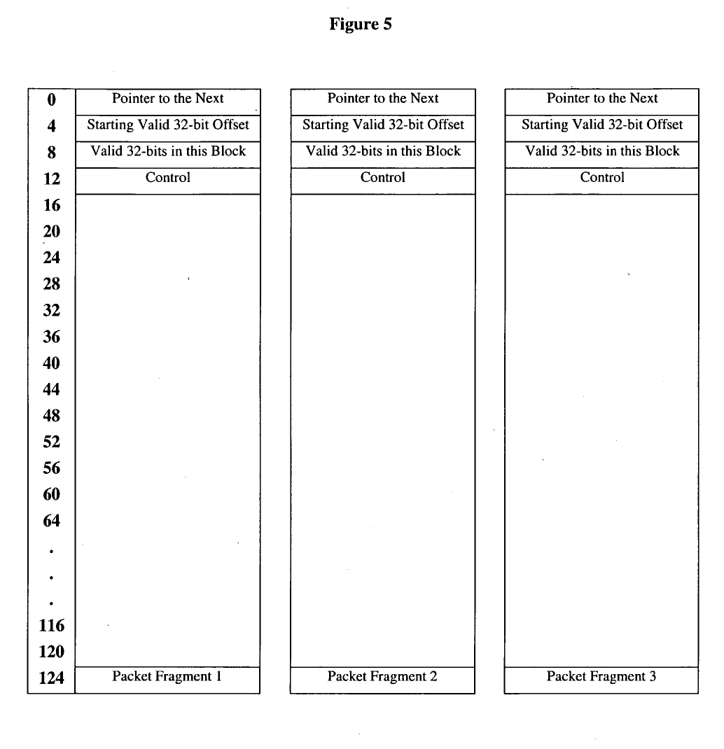

Packet Storage Memory 105 may be used to store all or a portion of incoming packets. By way of example, FIG. 5 depicts one embodiment of the configuration of Packet Storage Memory 105. In this embodiment, a control field contains information relating to the actual packet transfer, such as CRC calculation, Tunneling Mode, etc. While in one embodiment, packets are stored in chunks of 128 bytes with a 16-byte header and 112 bytes for each packet segment, it should equally be appreciated that other packet storage configurations may be used. In another embodiment, packets may be stored in a linked list fashion. As will be described in more detail below, Packet Storage Memory 105 may be accessed both on the ingress side (via internal bus 110) as well as the egress side (via internal bus 155).

The Ingress Line Interface Processing engine (ILIP) engine 140 may be tied with the frame/packet headers belonging to a particular line interface. As mentioned above, when a packet is received, the IPS logic 100 may store the required header in an IHPQ 115. In one embodiment, the ILIP engine 140 may perform packet classification operations using the destination address in the header to fetch the route table for this frame (which may be one using either CAM/hashing function). While a given packet is being classified, IPS logic 100 may store the payload in the Packet Storage Memory 105.

Using the route table information and the header information packet/frame, the ILIP engine 140 classifies each packet as either a tunneling packet, a management packet or a virtualization packet, according to one embodiment. For a tunneling packet, the ILIP engine 140 may setup the “V” header bit indicating that it is a tunneling packet. In another embodiment, the ILIP engine 140 may also copy the routing information for the Fabric Interface 145. If no routing information is present, or if a “CPU” bit is set in the route table, the tunneling mode may be used to send the packet to the management card 60 for further processing. With respect to management packets, such packets may be used to update line card resources.

For a virtualized packet, the ILIP engine 140 may fetch connection information from VCI table 130 using certain fields (e.g., from the packet/header). Thereafter, a check may be made for supported protocol types (IP, SCSI, RDMA, etc.), and if not supported, tunneling mode may be used to transfer the packet to the management card 60. In one embodiment, checking for protocol type may involve doing one or more of the following: creating an I/O Context and sending a modified packet to the Fabric Interface 145 with the appropriate virtualization and routing information; destroying the I/O Context and sending a modified packet to the Fabric Interface 145; and/or scheduling a packet transmission for the Fabric Interface 145 using the virtualized information.

Moreover, given that multiple line cards 30₁-30ₙ can be connected through the fabric interface 145, flow control between the lines cards may be accomplished using one or more virtual queue(s) 142. The virtual queue(s) can be either static (with fixed depth) or dynamic. Information relating to the line card 30, the actual packet start address and packet length may be stored in the O/P line card buffer information block 143. In one embodiment, the O/P line card buffer information may be used by the virtual queue block 142 to transfer the packet to the internal fabric interface 145.

Continuing to refer to FIG. 2, the Egress Packet Steering (EPS) logic 150 may be used to steer packets from the Fabric Interface 145 and to the Packet Storage Memory 105 and/or the Egress Header Processing Queue (EHPQ) 160. It should be noted that EPS logic 150 may access Packet Storage Memory via internal bus 155 since in the embodiment of FIG. 2 the Packet Storage Memory 105 is also coupled to Internal Bus 155.

With respect to EHPQ 160, this block may be used for processing a packet by either updating the resources (in the case of a management packet), or transmitting a packet to the O/P line interface. Obviously the particular protocol type will cause this block to perform varying operations.

The Egress Fabric Interface Processing (EFIP) engine 165 may be responsible for transmitting packets out on the Egress Line Interface 85. In one embodiment, this block is specific to the particular Line Card 30, and may be responsible for forming the appropriate line interface framing/packet structure from the information provided by the Fabric Interface 145. Moreover, the EFIP engine 165 may interface with Egress Line Transfer Queue 170 to ensure that data properly flows to Egress Line Interface 85.

III. Packet Headers

In the embodiment described above, there are 3 types of packets—tunneling, management and virtualized packets. Each type of packet may encapsulate the actual payload (e.g., SCSI or IP) with a special header. However, in one embodiment, all types of packets contain a slim header, such as the following:

| | |
|---|---|
| 0 | Protocol Type |
| 1 | Protocol Opcode |
| 2 | |
| 3 | Payload Length |

The Protocol Type can be any protocol, including any of the following: Tunneling, Management, Control Packets, SCSI Packet, RDMA Packet, and IP Packet. In one embodiment, the packet steering logic (e.g., IPS logic 100 and EPS logic 150) is aware of these protocol types and is able to store the packet in the Packet Storage Memory 105 and header storage in the IHPQ 115. The Protocol Opcode will be dependent on the Protocol Type.

With respect to Tunneling Packets, at the ingress side to determine if a packet is a Tunneling Packet, the Route Table's “V” bit may be used. For such packets, only a slim header need be attached on every packet passing through the Line Card 30. At the egress side, such packets may be transmitted without modification.

Management Packets may be issued either by the management card 60 (possibly to request/update resources on the line card) or by the Line Card 30 (if the “CPU” bit in the Route Table is set). In the latter case, the entire packet may be encapsulated with the slim header and transmitted to the management card 60, according to one embodiment. Apart from the slim header, these packets may carry a management header that defines Resource Address and the actual length information, according to one embodiment. These resources may include Route Tables 125, VCI tables 130, etc. The Resource Address can be of varying length depending on the resource.

With respect to virtualized SCSI Packets, their Protocol OpCode may be used to define the actual SCSI operation (Command, Status, Data, Transfer Ready) to be carried out.

As described above, IHPQ 115 and EHPQ 160 are used to process packet data that passes through Line Card 30. Packet steering logic (e.g., IPS logic 100 and EPS logic 150) may be used store the appropriate header information in these queues. While only two queues are depicted in FIG. 2, it should equally be appreciated that more queues may be used. In such a case, additional queues (not shown) may be defined for virtualized and non-virtualized paths.

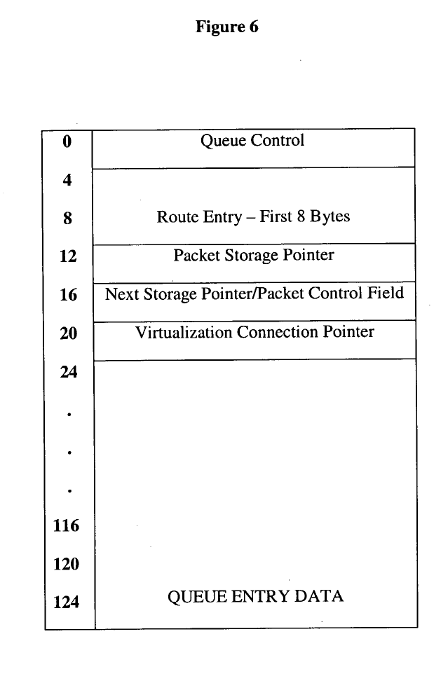

Referring now to FIG. 6, in which one embodiment of an IHPQ entry is depicted. It should be appreciated that the actual number of queue entries in a given header processing queue may be determined based on the amount of processing required for the longest processing path. In one embodiment, a common header may be used for all types of queue entries, wherein the common header may contain queue control information and the actual route entry itself. Examples of queue control information include physical port information, packet storage completion bit, CRC error detected bit, ready-for-processing bit, payload length, etc.

The Queue Entry Data of FIG. 6 contains, in one embodiment, the actual header that is to be processed by the processing engines (e.g., ILIP engine 140). The actual content may depend on the given interface and protocol at issue.

IV. Data Flow

The manner in which data flows through Line Card 30 will depend in part on the given interface and protocol. This section will describe how data flows through a Line Card 30 consistent with the present invention for some of the possible types of packets. However, it should obviously be appreciated that there are numerous other types of packets and interface/protocol configurations for which the Line Card 30 may be used. The following are but exemplary data flow embodiments.

A. Tunneling Mode

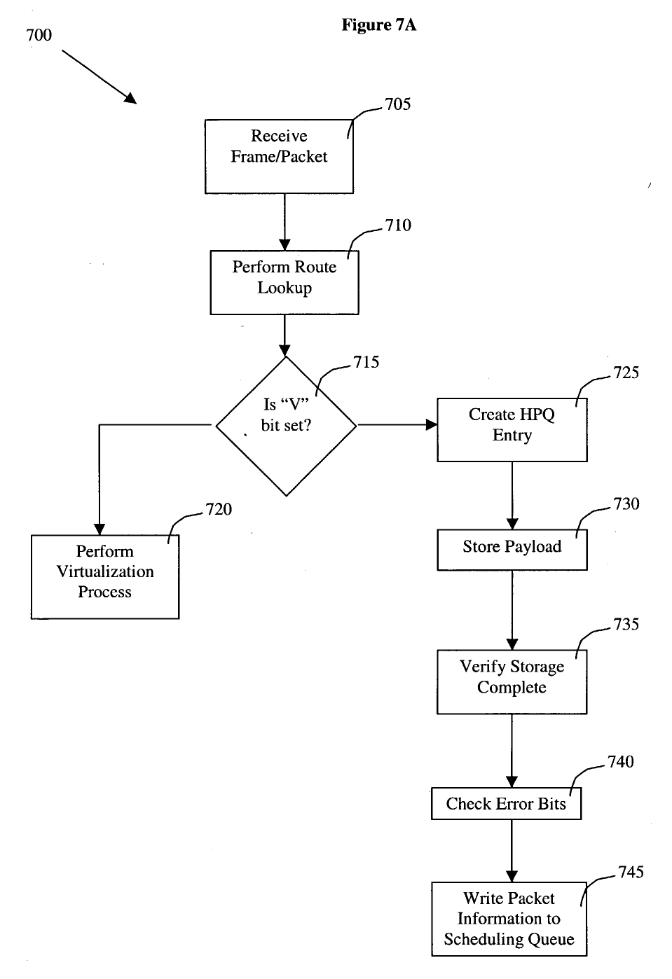

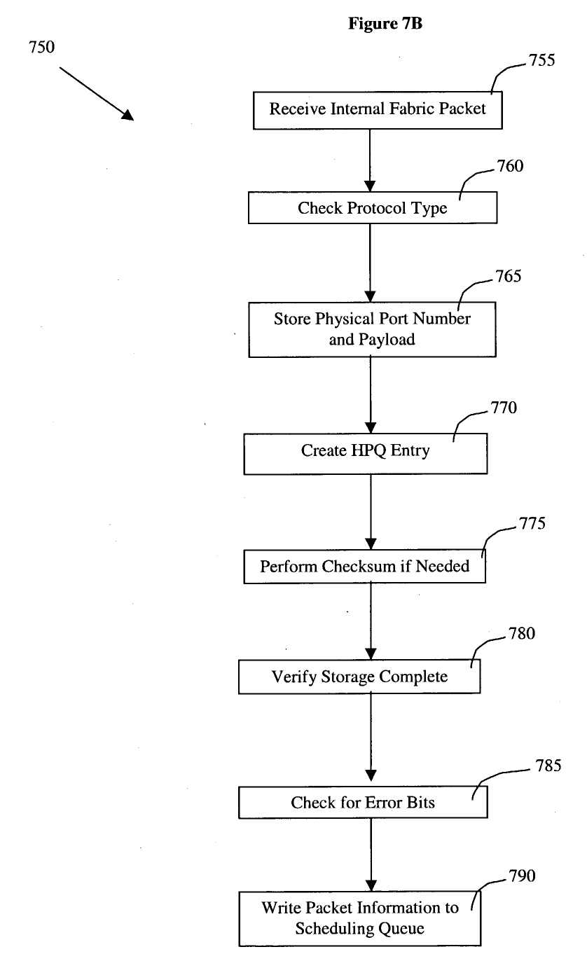

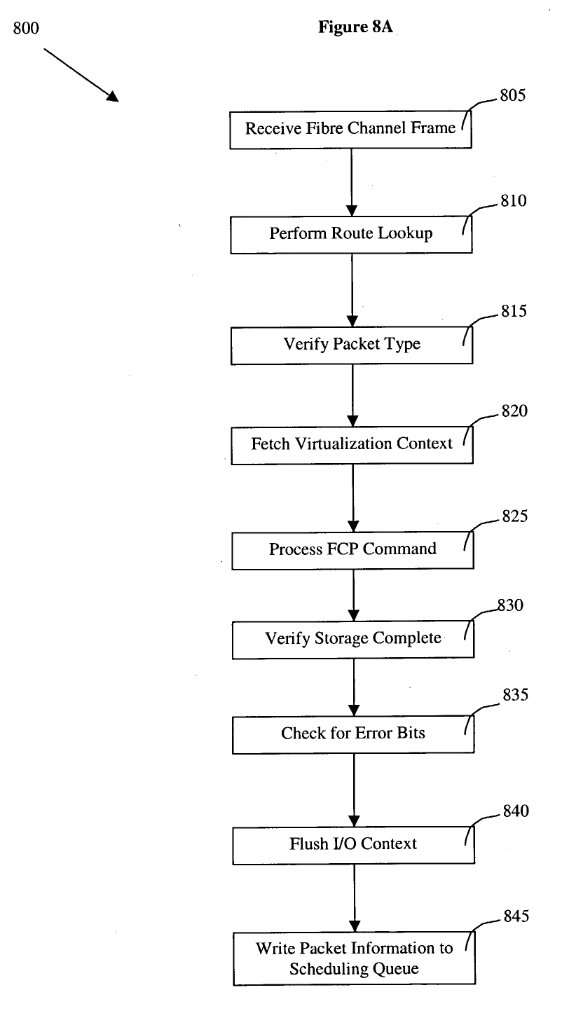

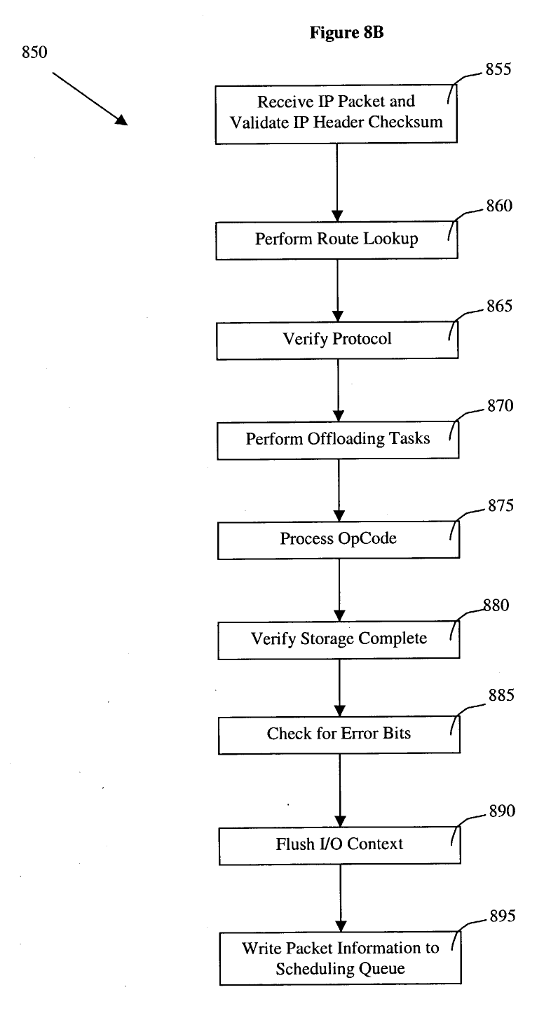

As mentioned previously, the Line Card 30 may process data in Tunneling Mode, which involves some data traffic being carried through the network interface 10 without terminating the protocol. FIG. 7A describes one embodiment of how ingress data is processed in Tunneling Mode. In particular, process 700 begins at block 705 where the packet/frame is receive by the Line Card 30. Using the destination address from the packet, a route lookup operation as previously discussed may be performed (block 710). At decision block 715, a determination is made as to whether the “V” bit has been set. If so, the packet in question is considered a virtualized packet and process 700 would then continue to block 720 where a virtualization process is performed for the interface in question (e.g., FCP, SRP and iSCSI). By way of example, the virtualization process for FCP and iSCSI has been described in more detail below with reference to FIGS. 8A and 8B.

Where the determination of decision block 715 indicates that the “V” bit has not been set, then process 700 continues to block 725 where a Header Processing Queue Entry is created using the Queue Control and the actual Route Entry. In the case of a Fibre Channel interface, the FC Frame Header may be stored in the Header Processing Queue (e.g., IHPQ 115), according to one embodiment. For other interfaces (e.g., Ethernet and IB), the appropriate packet headers may be stored in the IHPQ 115 so that further classification may be done by the ILIP engine 140.

At block 730, process 700 stores the remainder of the packet, including the EOF, in Packet Storage Memory 105. Thereafter, one or more bits from the Queue Control may be polled to verify that the packet payload has been completely stored (block 735). In the embodiment of FIG. 7A, process 700 then continues with checking for any error bits which may have been set during packet processing (block 740). If there are none, then at block 745 the packet start address and length are written to the O/P line card virtual queue, along with any O/P line card information.

Referring now to FIG. 7B, in which one embodiment of a process 750 for egress Tunneling Mode processing is described. In particular, process 750 begins when the internal Fabric Packet with the slim header is received by the Egress Header Processing Queue (block 755). At block 760 a protocol-type check is performed to verify that it is a Tunneling Mode packet. Thereafter, at block 765 the Physical Port Number may be extracted from the Fabric Route Header and saved. The packet that follows the slim header may then be saved to the Packet Storage Memory 105 (coupled to the egress side via internal bus 155).

At block 770, a Header Processing Queue Entry may be created indicating the Physical Port Number and the slim header along with the starting packet address. Thereafter, a CRC or checksum may be performed (775). In one embodiment, one or more bits from the Queue Control may be polled to verify that the packet payload has been completely stored (block 780). In the embodiment of FIG. 7B, process 750 then continues with checking for any error bits which may have been set during packet processing (block 785). If there are none, then the packet start address and length are written to the O/P scheduling queue, along with any O/P line card information (block 790).

B. SCSI Processing

As mentioned above, if the “V” bit has been set for a given packet, then the packet is to be processed as a Virtualized Packets and not a Tunneling Mode packet. It should be appreciated that Virtualized Packets may be processed according to any type of protocol, including SCSI, RDMA, and IP. In the case of SCSI processing, processing may depend on the given line interface and the actual encapsulated protocol. By way of example, FIG. 8A describes one embodiment (process 800) for ingress SCSI processing of an FC frame. In particular, process 800 begins with the reception of the FC frame at block 805. A route lookup may then be performed at block 810. The “V” bit and “CPU” bit may also be polled to verify that it is a Virtualized Packet. Thereafter, the FC frame header may be checked at block 815 to verify that the packet type is FCP. In one embodiment, non-FCP packets are forwarded to the Management Card 60 using a management packet header with “CPU Packet” as the Protocol Opcode. Process 800 continues to block 820 where the virtualization context may be fetched using the Source ID (S_ID) and Destination ID (D_ID) from the frame header. Thereafter, in the embodiment of FIG. 8A, the FCP command is processed (block 825). The operations to be carried out depend on the particular FCP command at issue. By way of example, possible processing operations for various FCP commands will now be described. However, it should be understood that other processing procedures may be employed and that other FCP commands may be processed.

In one embodiment, an FCP_CMND packet may be processed as follows: the entire FCP_CMND is stored in the IHPQ 115 along with the FC Header for further processing, SCSI information is validated, I/O context is created for this I/O, save off all parameters needed from the Frame Header and from the FCP_CMND, and allocate a memory pointer and store the I/O Command Header to the Packet Storage Memory 105.

In the case of an FCP_XFER_RDY packet, the following processing procedure is one embodiment that may be employed: fetch the I/O Context using the OX_ID received from the FC Frame, validate ‘Transfer RDY Count’ received and save it off in the I/O Context, create an ‘I/O Ready To Transfer’ header to the O/P Line Card, allocate a memory pointer and store the packet in the Packet Storage Memory 105.

Similarly, in the case of an FCP_DATA packet, in one embodiment the processing procedure may be as follows: store FC Header in a header queue while the data payload is stored in the external memory (e.g., Packet Storage Memory 105), allocate memory pointers, store the start packet address is the queue, fetch the I/O Context using the OX_ID/RX_ID received from the FC frame, prepare the I/O Data Pass-Through Header and save off this header.

In the case of an FCP_RSP frame, one embodiment of the processing procedure is to: store the entire packet in the Header Queue along with the header, fetch the I/O Context using the OX_ID received from the FC frame, prepare an I/O Status Header and store this in the Packet Storage Memory 105 after allocating a pointer thereto, and destroy the I/O Context.

Referring back to FIG. 8A, once the FCP command has been processed, process 800 continues to block 830 where one or more bits from the Queue Control may be polled to verify that the packet payload has been completely stored. Process 800 then continues with checking for any error bits which may have been set during packet processing (block 835). If none, then the I/O context is flushed (block 840) and the packet start address and length are written to the O/P scheduling queue, along with any O/P line card information (block 845).

In addition to a SCSI interface, the Line Card 30 may also process iSCSI from an Ethernet interface. To that end, process 850 of FIG. 8B illustrated one embodiment for processing an IP packet from Ethernet. Beginning at block 855, an IP packet is received from the Ethernet interface and the IP Header Checksum validated. A route lookup may then be performed at block 860 as previously discussed. The “V” bit and “CPU” bit may also be polled to verify that it is a Virtualized Packet.

At block 865, the IP Protocol may be checked to ensure that it matches TCP, according to one embodiment. For other protocols, the Tunneling Mode of FIGS. 7A-7B may be performed and the packet routed to the Management Card 60. In another embodiment, multiple communication paths between multiple devices on different interfaces may be possible. Thereafter, TCP Offloading and iSCSI offloading tasks may be performed at block 870 (e.g., TCP checksum, iSCSI Data CRC checking, iSCSI encryption, etc.). At this point, the iSCSI headers may be steered to the IHPQ 115 and the payload stored in the Packet Storage Memory 105. In one embodiment, fetching of the virtualization context using the information in the IP and TCP Headers may be done at this point as well.

Continuing to refer to FIG. 8B, the OpCode in the iSCSI header may be processed (block 875), where the particular OpCode determines what additional operations are to be carried out. For example, in the case of a SCSI Command, the entire packet, along with the iSCSI Header, may be stored in the IHPQ 115. Thereafter, the SCSI information may be validated, the I/O Context created, needed parameters from the iSCSI Command saved off, and a memory pointer to the stored I/O Command Header allocated.

Similar, where the OpCode is a SCSI Response, the following is one embodiment of the processing procedure that may be employed: the packet, along with the iSCSI Header, is stored in the IHPQ 115, the I/O Context is fetched (possibly using the Initiator Task Tag), and an I/O Status Header is prepared and stored in the Packet Storage Memory 105.

It should be appreciated that these OpCode processing descriptions are provided by way of example only and that other processing sequences may similarly be employed. It should further be appreciated that other OpCodes, such as SCSI Data-In, SCSI Data-Out, and Ready To Transfer, may require additional and/or different processing operations to be carried out.

Referring back to FIG. 8B, following the OpCode processing, process 850 may continue with the polling of one or more bits from the Queue Control to verify that the packet payload has been completely stored (block 880). In one embodiment, error bits may then be checked (block 885), and the I/O context flushed (block 890). Thereafter, the packet start address and length may be written to the O/P scheduling queue, along with any O/P line card information (block 895).

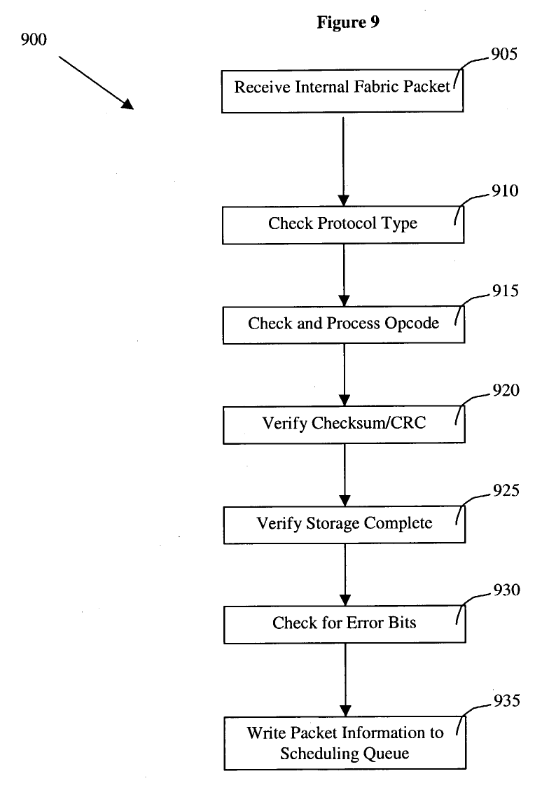

Packet processing is also performed on the egress side. As such, FIG. 9 illustrates one embodiment for egress SCSI processing (process 900). In one embodiment, egress SCSI processing is processed by two engines—the EPS Logic 150 and the EFIP engine 165. While the initial processing may be done by the EPS Logic 150, the actual transmission may be done by the EFIP engine 165, according to one embodiment.

In any event, process 900 begins with the receipt of the internal fabric packet to the EPS logic 150 (block 905). At block 910, the protocol type is checked to determine if the packet belongs to one of the I/O Packets groups. In one embodiment, all the other packet types are processed using the respective data flow's algorithm.

Process 900 may then check and process the Protocol Opcode for the given internal fabric packet (block 915). The particular processing operations to be carried out on the packet will depend on the specific Opcode. The following are examples of how various Opcodes may be processed:

I/O Command

Save off the fabric packet excluding the trailer in the processing queue (e.g., EHPQ 160);

Obtain the virtualization context from the handle in the packet;

Create an I/O Context;

Construct Packet Header—based on the physical port and line interface, construct either SRP_CMND (along with the IB Header) or iSCSI Command Header (BHS along with the TCP/IP). In case of Fiber Channel, create only the FC Frame Header and copy the FCP_CMND from the I/O Command Header using information from the virtualization context; and

Acquire a memory pointer, and store the block prepared to packet storage memory 105 (coupled to the egress processing engine via internal bus 155).

I/O Status

Save off the fabric packet excluding the trailer in the processing queue (e.g., EHPQ 160);

Obtain the I/O Context from the I/O Status Header (e.g., using the Initiator Context Pointer);

Construct Packet Header—based on the physical port and the line interface, construct either SRP_RSP (along with the IB Header) or iSCSI Status Header (BHS along with the TCP/IP). In case of Fiber Channel, use the I/O Status Header itself; and

Acquire a memory pointer, and store the block prepared to Packet Storage Memory 105 (coupled to the egress processing engine via internal bus 155).

I/O Ready to Transfer

Save off the fabric packet excluding the trailer in the processing queue (e.g., EHPQ 160);

Obtain the I/O Context from the I/O Status Header (e.g., using the Initiator Context Pointer);

Construct Packet Header—based on the physical port and the line interface, construct either an RDMA Read Request (IB), R2T (iSCSI) or Transfer Ready (FC) using information in the virtualization context where the payload may be in the Fabric Packet itself. Also for IB, the I/O Context may be saved off in the virtualization context to process RDMA Read Responses; and

Acquire a memory pointer, and store the block prepared to Packet Storage Memory 105 (coupled to the egress processing engine via Internal Bus 155).

I/O Data Pass Through

Save off the I/O Data Pass-Through Header along with slim header in the header processing queue (e.g., EHPQ 160);

Save off the rest of payload in a linked-list fashion;

Fetch I/O Context as well as the Virtualization Handle using the header received; and

Create the interface specific header and store the header in the space reserved for this purpose.

Referring back to FIG. 9, after processing the Opcode process 900 may then continue to block 920 where the Checksum/CRC of the internal fabric packet is verified. In one embodiment, this verification function may be accomplished using the Fabric Trailer, which in one embodiment includes only either a CRC or a checksum for the fabric packet.

In the embodiment of FIG. 9, Process 900 then continues with the polling of one or more bits from the Queue Control to verify that the packet payload has been completed stored (block 925). In one embodiment, error bits may then be checked (block 930). Thereafter, the packet start address and length may be written to the O/P scheduling queue, along with any O/P line card information (block 935).

C. IP Processing

In one embodiment, IP processing may be done on IB and Ethernet using a Layer-3 switching manner, rather than routing. In another embodiment, IP packets are not connection oriented and there is no need to have a VCI table 130. In yet another embodiment, for the ingress side of IB, Queue Pair (QP) information is maintained, while on the egress side a table lookup may be used to obtain the QPN Queue Pair Number (QPN) associated with a particular IP address.

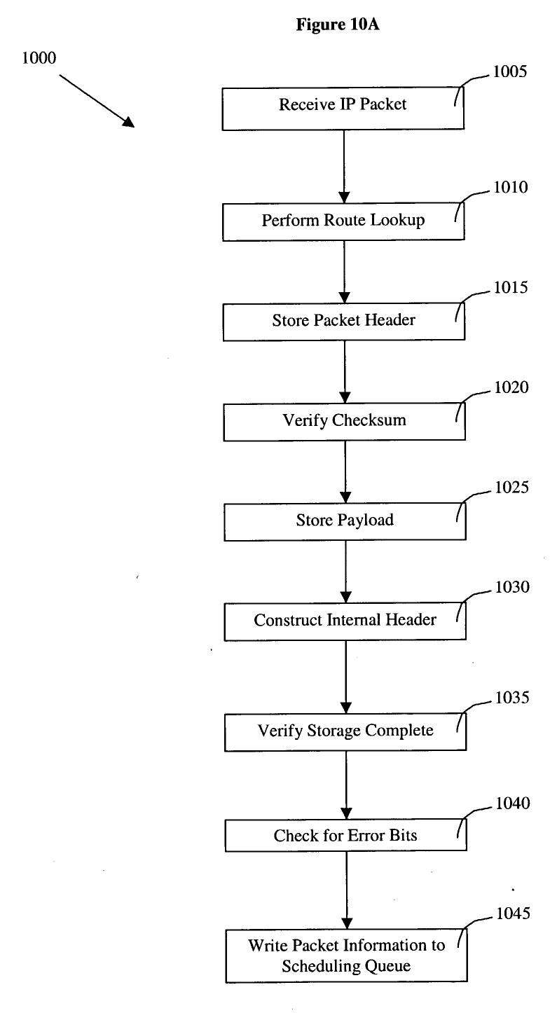

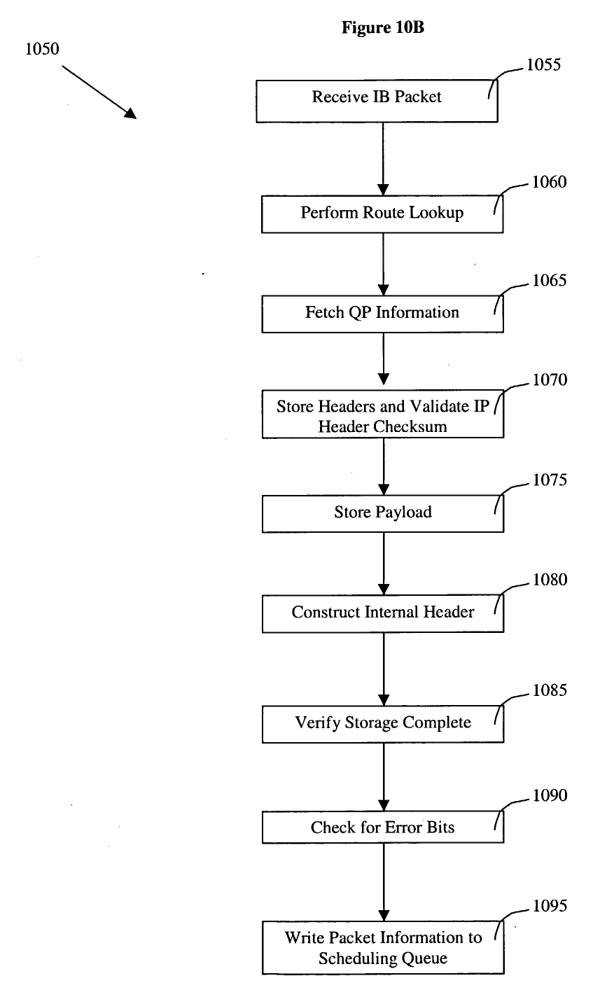

Referring now to FIG. 10A, in which a process for handling ingress IP from Ethernet is described (process 1000). In particular, an IP packet is received at block 1005. A route lookup may then be performed at block 1010 using the IP Destination Addresses. If Route Table 125 entry indicates this is a “CPU” packet, then the packet may be sent to the Management Card 60 for further processing. If, on the other hand, the Route Table 125 entry has its “V” bit set, then the packet is a virtualized packet and the virtualization functionality (e.g., for SCSI, RDMA, etc.) may be performed.

At block 1015, the packet header may be stored in IHPQ 115, along with the Route Entry and Queue Control settings. Thereafter, the IP header checksum may be verified (block 1020), and the remainder of the packet stored in the Packet Storage Memory 105 (block 1025). In one embodiment, the packet address may be reported back to the IHPQ 115.

At this point in process 1000, the internal IP header may be constructed and saved in the Packet Storage Memory 115 (block 1030). In one embodiment, process 1000 may then poll one or more bits from the Queue Control to verify that the packet payload has been completed stored (block 1035). Error bits may then be checked (block 1040). Thereafter, the packet start address and length may be written to the O/P scheduling queue, along with any O/P line card information (block 1045).

Referring now to FIG. 10B, in which one embodiment of a process 1050 for IP processing from an IB interface is set forth. The process 1050 begins at block 1055, where the IB packet is received. Using information from the packet (e.g., DLID), a route lookup may be performed (block 1060), as previously detailed. In one embodiment, the packet is classified based on the “CPU” and “V” bits of the packet.

Thereafter, at block 1065 the QP information may be fetched (e.g., using the destination QPN from the packet). In one embodiment, the QP information contains information on the protocol. Thereafter, the IB header along with the IP header may be stored and the IP header checksum validated (block 1070). The remainder of the of the packet may then be stored in the Packet Storage Memory 105 (block 1075). In another embodiment, an indication of the packet address is also sent to the IHPQ 115.

At this point in process 1050, the internal IP header may be constructed and saved to the Packet Storage Memory 105 (block 1080). One or more bits from the Queue Control may then be polled to verify that the packet payload has been completed stored (block 1085). Error bits may then be checked (block 1090), and the packet start address and length may be written to the O/P scheduling queue, along with any O/P line card information (block 1095).

On the egress side, in one embodiment IP Processing involves removing the internal IP header and transmitting the packet to the physical port as indicated by the route header. In another embodiment, a table is maintained to get the Layer-2 addresses/information for the IP Addresses.

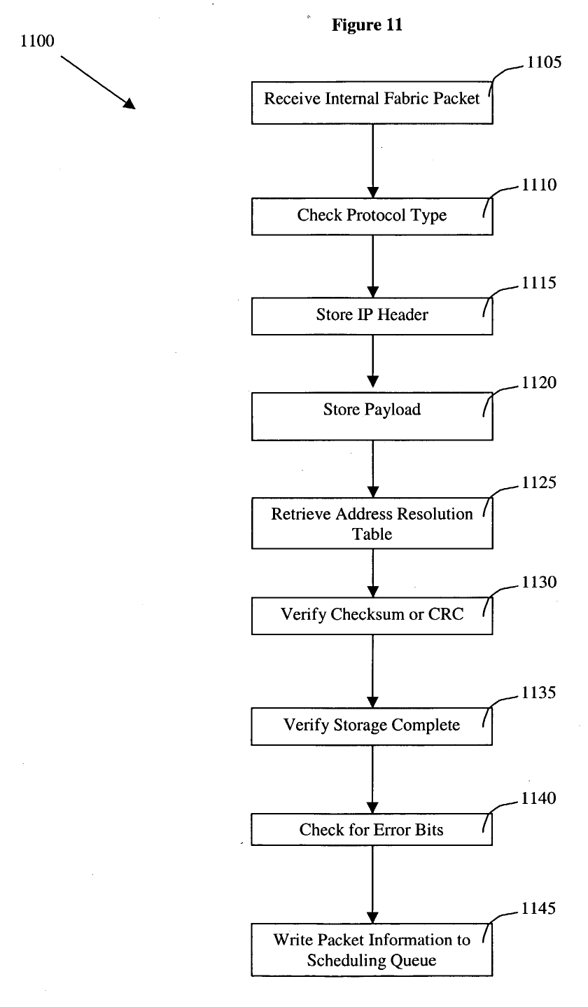

FIG. 11 describes one such embodiment for egress IP processing. In particular, process 1100 begins with the reception of the internal fabric packet from the Fabric Interface (block 1105). At block 1110, the protocol type is checked to determine if the packet is an IP packet. In one embodiment, all the other packet types are processed using the respective data flow's algorithm. At block 1115, the IP header along with the slim header may be saved in the EHPQ 160. Moreover, the rest of payload may be saved in a linked-list fashion in the Packet Storage Memory 115, as previously discussed.

Thereafter, an Address Resolution Table may be retrieved (block 1125), which in one embodiment may be done using the Virtualization Connection Handle. In another embodiment, the Address Resolution Table may contain information to setup the Layer-2 headers for Ethernet and IB Header for Infiniband IP networks.

The checksum or the CRC of the internal fabric packet may then be checked at block 1130 (e.g., possibly using the Fabric Trailer). Thereafter, one or more bits from the Queue Control may then be polled to verify that the packet payload has been completed stored (block 1135). Error bits may then be checked (block 1140), and the packet start address and length may be written to the O/P scheduling queue, along with any O/P line card information (block 1145).

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method of bridging network protocols comprising:
receiving a data packet using a first network interface having a first protocol;
performing a route lookup operation using one or more hardware components and one or more software components, said route lookup operation to provide route information for said data packet; and,
routing said data packet, based on the route information, to a second network interface having a second protocol.

2. The method of claim 1, further comprising, prior to said routing:
storing a header of said data packet in a memory queue; and,
storing a payload of said data packet in a packet storage memory.

3. The method of claim 2, further comprising:
generating a modified header of said data packet; and,
transmitting the modified header and payload to an internal fabric interface.

4. The method of claim 2, further comprising storing a plurality of packets in said packet storage memory in a link-list fashion.

5. The method of claim 1, further comprising:
establishing a virtual connection between a first network device, coupled to the first network interface, and a second network device, coupled to the second network interface; and,
creating a virtual connection information table that includes connection information for said first device and second device.

6. The method of claim 1, wherein said one or more software components are implemented using one or more Reduced Instruction Set Computer (RISC) engines.

7. The method of claim 1, further comprising:
terminating the first protocol for said data packet;
routing said data packet through an internal fabric according to a proprietary protocol; and,
transmitting said data packet using to second network interface according to said second protocol.

8. The method of claim 1, wherein said second protocol is different than said first protocol, and said first and second protocols are one of InfiniBand, Fiber Channel and Ethernet.

9. The method of claim 1, wherein performing a route lookup operation comprises performing one of a hashing operation and a Content Addressable Memory (CAM) lookup.

10. The method of claim 1, wherein said performing the route lookup operation further comprises performing the route lookup operation using a destination address from said data packet.

11. The method of claim 1, further comprising categorizing said data packet into one of a virtualized packet, a tunneling packet and a management packet.

12. The method of claim 11, wherein upon categorizing said data packet as the tunneling packet, the method further comprises tunneling said data packet through an internal fabric interface and a second network interface without terminating said first protocol.

13. The method of claim 11, wherein upon categorizing said data packet as the management packet, the method further comprises directing said data packet to a management processor.

14. An apparatus to bridge network protocols comprising:
a first network interface having a first protocol, said first network interface to receive a data packet;
a second network interface having a second protocol; and
a packet processing engine comprised of one or more hardware components and one or more software components, said packet processing engine to,
perform a route lookup operation to provide route information for said data packet, and
routing said data packet, based on the route information, to the second network interface.

15. The apparatus of claim 14, wherein said apparatus further comprises a memory queue and a packet storage memory, said packet processing engine further to,
store a header of said data packet in the memory queue, and
store a payload of said data packet in the packet storage memory.

16. The apparatus of claim 15, wherein said packet processing engine further is to,
generate a modified header of said data packet, and
transmit the modified header and payload to an internal fabric interface.

17. The apparatus of claim 15, wherein said packet processing engine is further to store a plurality of packets in said packet storage memory in a link-list fashion.

18. The apparatus of claim 14, wherein said packet processing engine is further to,
establish a virtual connection between a first network device, coupled to the first network interface, and a second network device, coupled to the second network interface; and,
create a virtual connection information table that includes connection information for said first device and second device.

19. The apparatus of claim 14, wherein said one or more software components of said packet processing engine is implemented using one or more Reduced Instruction Set Computer (RISC) engines.

20. The apparatus of claim 14, wherein said packet processing engine further is to,
terminate the first protocol for said data packet,
route said data packet through an internal fabric according to a proprietary protocol, and
transmit said data packet using to second network interface according to said second protocol.

21. The apparatus of claim 14, wherein said second protocol is different than said first protocol, and said first and second protocols are one of InfiniBand, Fiber Channel and Ethernet.

22. The apparatus of claim 14, wherein said route lookup operation comprises performing one of a hashing operation and a Content Addressable Memory (CAM) lookup.

23. The apparatus of claim 13, wherein said packet processing engine performs said route lookup operation using a destination address from said data packet.

24. The apparatus of claim 14, wherein said packet processing engine further is to, categorize said data packet into one of a virtualized packet, a tunneling packet and a management packet.

25. The apparatus of claim 24, wherein upon categorizing said data packet as the tunneling packet, said data packet processing engine tunnels said data packet through an internal fabric and to the second network interface without terminating said first protocol.

26. The apparatus of claim 24, wherein upon categorizing said data packet as the management packet, said data packet processing engine directs said data packet to a management processor.
